(19) United States
(12) Patent Application Publication
(10) Pub. No.: US 2016/0267592 A1
(43) Pub. Date: Sep. 15, 2016

(54) MATCHING REMOTE TRADING SYSTEM FEES AND REBATES

(71) Applicant: TSX INC., Toronto (CA)

(72) Inventor: Deana DJURDJEVIC, Toronto (CA)

(21) Appl. No.: 15/033,330

(22) PCT Filed: Mar. 6, 2015
(86) PCT No.: PCT/CA2015/000143

§ 371 Date: Apr. 29, 2016

Related U.S. Application Data
(60) Provisional application No. 61/949,500, filed on Mar. 7, 2014.

(51) Int. Cl. G06Q 40/04; G06F 17/30

(52) U.S. Cl. CPC G06Q 40/04; G06F 17/30867

(57) ABSTRACT

A local trading system captures remote fee data published by at least one remote trading system. The remote fee data is indicative of fees, rebates, or a combination of such applied to orders made by trading entities for execution of trades of the financial security at the remote trading system. The local trading system executes trades for the financial security and calculates fees, rebates, or combination of such for the executed trades based on the remote fee data. The calculated fees, rebates, or combination of such based on the remote fee data are applied to the executed trades made by the local trading system. The local trading system can thus match fees and rebates offered by one or more remote trading systems.

### CROSS-REFERENCE TO RELATED APPLICATIONS

This application claims priority to U.S. 61/949,500, filed Mar. 7, 2014, the entirety of which is incorporated herein by reference.

### FIELD

This present invention relates to computers and, more specifically, to computerized trading.

### BACKGROUND

In computerized trading systems, such as modern stock exchanges, orders can specify a wide array of parameters and conditions. It is well known for an order to specify that a stock be purchased at the best available price, which may be known as the national best bid and offer (NBBO). It is also known to peg an order's price to that of another order. Such techniques can help ensure that trades are executed in the best interests of the trader.

Fees and rebates for executing trades vary from exchange to exchange and can amount to a significant consideration for traders. A trader may wish to route a trade to an exchange that has low fees or offers high rebates, as the case may be. However, there currently exists no solution for an exchange to be able to quickly and efficiently set its fees and rebates in order to stay competitive with other exchanges.

### SUMMARY

According to one aspect of the present invention, a method includes performing order matching for at least one financial security at a local trading system, the local trading system having at least one computer connected to a computer network. The method further includes capturing remote fee data published by at least one remote trading system via the computer network. The remote fee data is indicative of fees, rebates, or a combination of such applied to orders made by trading entities for execution of trades of the financial security at the remote trading system. The method further includes executing trades for the financial security at the local trading system, and the local trading system calculating fees, rebates, or combination of such for the executed trades based on the remote fee data. The method further includes applying the calculated fees, rebates, or combination of such to the executed trades.

According to another aspect of the present invention, a trading system includes an order matching engine configured to match orders for at least one financial security. The order matching engine is connected to a computer network and configured to receive orders for the financial security via the computer network. The system includes an order book database configured to store rested orders for the financial security. The order matching engine is further configured to access the order book database to match orders. The system further includes a fee engine configured to capture remote fee data published by at least one remote trading system via the computer network. The fee engine is further configured to apply fees, rebates, or a combination of such to executed orders based on the captured remote fee data.

### BRIEF DESCRIPTION OF THE DRAWINGS

The drawings illustrate, by way of example only, embodiments of the present invention.

FIG. 1 is a block diagram of a computer system.

FIG. 2 is a block diagram of a trading server.

FIG. 3 is a block diagram of components of a fee engine and fee data.

FIG. 4 is a flowchart of a method of capturing and applying fees/rebates for trades of financial securities.

FIG. 5 is a flowchart of a method of calculating a fee/rebate.

FIG. 6 is a flowchart of another method of capturing and applying fees/rebates for trades of financial securities.

FIG. 7 is a schematic diagram of data structures for a remote fee data, an order book feed, and a fee/rebate schedule.

### DETAILED DESCRIPTION

A local trading system captures remote fee data published by at least one remote trading system. The remote fee data is indicative of fees, rebates, or a combination of such applied to orders made by trading entities for execution of trades of the financial security at the remote trading system. The local trading system determines fees, rebates, or combination of such for its executed trades based on the remote fee data. The calculated fees, rebates, or combination of such based on the remote fee data are applied to the executed trades made by the local trading system. The local trading system can thus match fees and rebates offered by one or more remote trading systems. This allows the local trading system to match dynamic fees/rebates being offered at a competing remote trading system. It further allows the local trading system to match static fee/rebate schedules of competing remote trading systems, such as those published on websites and in other documents. One benefit of this is that fees and rebates can be made more competitive.

The terms “fee data” and “fee information” are used herein to indicate fees, rebates, or a combination of such. A rebate can be viewed as a negative fee and vice versa. Fees and rebates can be unit fees and rebates to be used as factors that are multiplied by price, volume, or other quantity to arrive at an actual fee or rebate that is charged or credited to a trading entity.

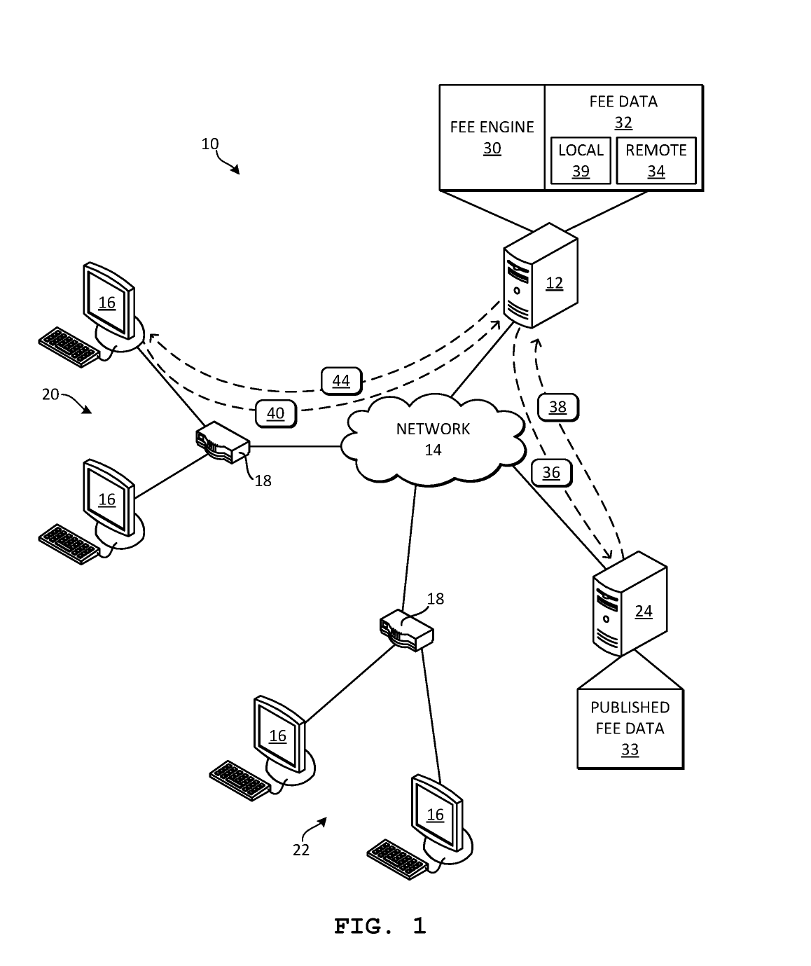

FIG. 1 shows a computer system 10 configured to allow trading of financial securities, such as equity securities and the like. Stocks will be used as an illustrative example, and in such examples the trading systems discussed herein may be referred to as exchanges. However, this is not limiting and the techniques discussed herein can be applied to exchange-traded funds (ETFs) and similar or other financial products, financial instruments, or securities. Further, the techniques discussed herein can be applied to other computerized trading systems operating in other marketplaces.

The system 10 includes at least one local trading system 12 connected to one or more computer networks 14. The local trading system 12 is operated by or on behalf of an trading corporation or entity. The local trading system 12 can be situated within a domain controlled by such an trading corporation or entity.

The system 10 further includes at least one remote trading system 24 connected to the computer network 14. The remote trading system 24 is operated by or on behalf of another trading corporation or entity. The remote trading system 14 can be situated within a domain controlled by such an trading corporation or entity.

The terms “local” and “remote” are a matter of perspective and are used herein to indicate that the trading systems 12, 24 are different systems located within different domains, and may be controlled by different trading corporations or entities. The invention will be described from the perspective of the local trading system 12. However, this does not preclude the trading system 24 from also being a “local” trading system that incorporates the techniques discussed herein. In actual implementation, a multitude of trading systems are provided by various parties, and one or more of such systems can employ the techniques discussed herein, while other systems may not.

The trading systems 12, 24 may each include any number of computers, such as trading servers and similar, as well as other types of devices, such as routers, switches, and the like. Each of the trading systems 12, 24 may include a network of connected computers that cooperate to realize order matching and trade execution.

The system 10 further includes trading computers 16 connected to the network 14 via network devices 18, such as access points, routers, switches, servers, and similar. The trading computers 16 belong to various domains 20, 22 controlled by different trading entities, such as brokers and the like. The trading computers 16 execute trading client programs that allow input of orders, transmission of orders to the trading systems 12, 24, and reception and output of results of such orders.

The network 14 can include any number and type of computer network, such as a local area network (LAN), wide-area network (WAN), virtual private network (VPN), intranet, and the Internet. The network 14 operates to communicatively couple the trading systems 12, 24 and the various trading computers 16, while isolating domains from one another and restricting communications between domains.

The local trading system 12 includes a fee engine 30 and fee database 32, among other components that will be discussed in detail below. The fee engine 30 is configured to capture, via the computer network 14, fee data 33 that is published by the remote trading system 24 and to store such fee data locally as captured remote fee data 34. The fee engine 30 is further configured to selectably apply fees, rebates, or a combination of such to orders executed at the local trading system 12 based on the captured remote fee data 34. In this way, the fee engine 30 allows trades executed by the local trading system 12 to honor fees/rebates published by the remote trading system 24. Thus, the local trading system 12 can match fees/rebates, charge lower fees, or pay out higher rebates in what can generally be termed “fee matching”.

The fee engine 30 issues capture requests 36 to the remote trading system 24 and receives and processes remote fee data 38 in response to such capture requests 36. Capture requests 36 can take the form of requests that specify the downloading of a webpage or portion thereof, the obtaining of feed content, the downloading of another type of document or portion thereof, or similar action. The remote fee data 38 received in response to the capture requests 36 can take the form of webpages or hypertext markup language (HTML) snippets, text/binary feed data, document text, or the like. Capture requests 36 can be performed according to a schedule, as triggered by orders at the local trading system 12 specifying fee matching, or according to another methodology. Capture requests 36 and remote fee data 38 can be communicated in accordance with any suitable protocol, such as a proprietary trading data feed protocol, the Hypertext Transfer Protocol (HTTP), or similar.

The fee engine 30 can be configured to match fees/rebates from a plurality of remote trading systems 24, and so the fee engine 30 may be configured to normalize any received remote fee data 38 before it is stored as captured remote fee data 34. Normalization places different formats of fee data from different remote trading systems into a common format. This can allow fee data from different remote trading systems to be readily compared and respond to the same queries.

The local trading system 12 may further store local fee data 39, which represents the regular fee/rebate schedule offered by the local trading system 12 when fee matching is not performed. The local fee data 39 may be stored in the same common format as the captured remote fee data 34.

The trading computers 16 are configured by a client program to allow an order 40 to specify that a fee charged by the local trading system 12 for executing a trade based on the order is to be equal to or less than a corresponding fee offered by the remote trading system 24, and that a rebate credited by the local trading system 12 is to be equal to or greater than a corresponding rebate offered by the remote trading system 24. Order completion responses 44 sent by the local trading system 12 to the trading computers 16 can contain a fee-matching statement 46 that the order was successfully executed with fee matching with details of the actual fee/rebate applied.

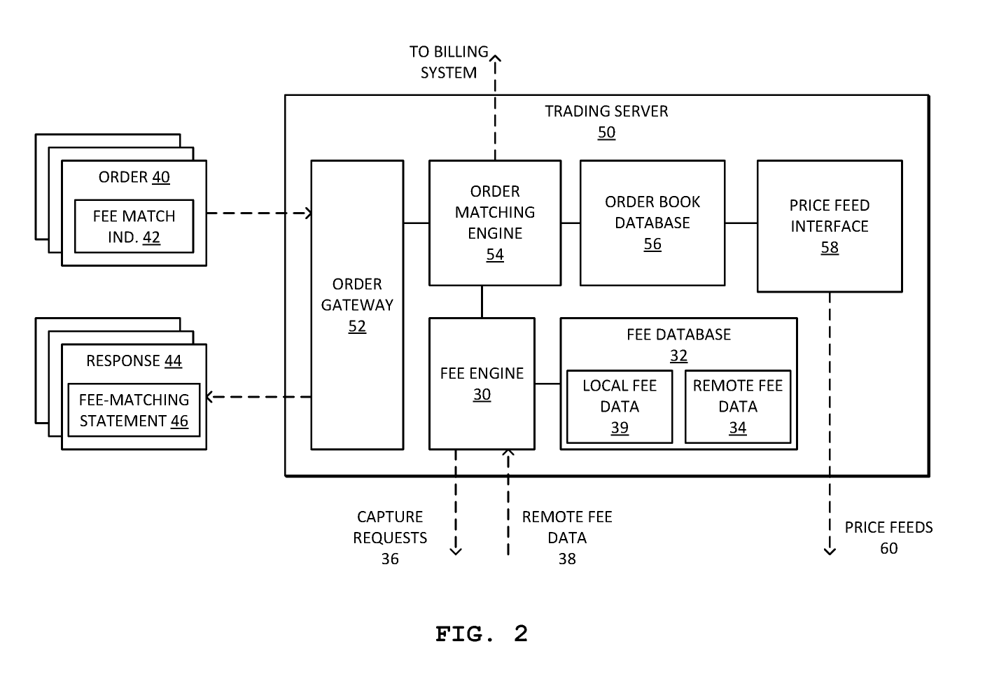

FIG. 2 shows details of a trading server 50 that can form part of or all of the local trading system 12. The trading server 50 can include any suitable computer, which can include one or more processors, one or more field-programmable gate arrays (FPGAs), memory (e.g., RAM, cache, etc.), mass storage devices, network adaptors, and user interface devices. These components are omitted from the figure for clarity. The components illustrated and discussed below may be implemented by programs stored in memory and executable by a processor or stored and executed by an FPGA.

In addition to the fee engine 30 and fee database 32, the trading server 50 includes an order gateway 52, an order matching engine 54, the order book database 56, and a price feed interface 58. The components 30, 32, 52-58 are illustrative and the distinct functionalities thereof may be combined into larger components or separated into smaller components based on specific implementation requirements. When more than one trading server 50 is used, the components 30, 32, 52-58 may be distributed among the servers 50 in various ways.

The order gateway 52 is configured to receive orders 40, which may contain fee-matching indications 42, from various trading computers 16 (FIG. 1) and to validate such orders 40. Because the orders 40 may be expressed in a protocol not used internally to the server 50, the order gateway 52 can also be configured to translate orders 40 from their protocol into a schema used within the trading server 50. An example of a suitable schema is a class that has properties, where at least one of such properties is configured to store information contained in a fee-matching indication 42. The order gateway 52 can be configured to map information transported by the fee-matching indication 42 of a specific order 40 to the respective property or properties of a specific instance of the class. Such a class may be used to instantiate objects compatible with the fee engine 30, fee database 32, and order book database 56.

The orders 40 and order completion responses 44 may be configured to conform to one or more various electronic trading protocols such as the Financial Information eXchange (FIX) protocol maintained by FIX Protocol, Ltd. as well as proprietary exchange protocols such as STAMP and the like.

The order gateway 52 can also be configured to timestamp orders 40 upon receipt by, for instance, reading a hardware clock of the server 50 and writing a timestamp to a property of the order class instance.

The order gateway 52 can further be configured to send order completion responses 44 to the various trading computers 16. The responses 44 can be configured to indicate whether and how orders 40 have been received and processed, and further, contain a fee-matching statement 46 indicative of any fee matching performed with details of any actual fee/rebate applied.

The order matching engine 54 is configured to process orders 40 by matching incoming orders 40 with orders present in the order book database 56. The order matching engine 54 is configured to rest an order 40 or a portion of an order 40 in the order book database 56, when the order or portion thereof is not able to be matched or if specified by the order 40. The order matching engine 54 can be configured to match orders based on price-time priority, price-fee-time priority, or other methodology. Price-time priority is well known. Price-fee-time priority ranks orders based on price, then on a specified fee or rebate willing to be paid or given up, and finally on time.

Regarding price-fee-time priority, orders 40 may specify a rebate give-up, which may be used if the order or a portion thereof becomes rested in the order book database 56. The rebate give-up specifies an amount of the exchange-provided rebate that a passive trading entity is willing to give up to an active trading entity for higher priority in the order book. When an incoming order 40 arrives at the order matching engine 54, the order 40 is considered an active order (unless specifically designated to be a passive order), and the order matching engine 54 attempts to match the active order 40 with a rested, passive order in the order book database 56. Upon matching orders, the active trading entity behind the active order 40 is charged a fee and the passive trading entity behind the matched passive order is given a rebate. If the passive order specified a rebate give-up, then that portion of the rebate is given to the active trading entity. On the other hand, if the incoming active order 40 cannot be fully completed, then the active order 40 or remainder thereof is rested in the order book database 56 as a passive order. At this time, the newly passive order may be ranked in the order book database 56 according to price, rebate give-up, and then time, such that, for orders at the same price, better rebate give-ups take priority. The same price-fee-time priority methodology can be used in scenarios where active orders are rebated and passive ones pay a fee.

The order book database 56 can be indexed by market (e.g., stock symbol). For each symbol, the order book database 56 can include one or more tables of bid orders and offer orders, which include data fields for volume, price, time, and rebate give-up or similar fee indication. Other data fields can also be provided.

The price feed interface 58 is configured to obtain data from the order book database 56 and construct data feeds 60 from such data. Feeds 60 can contain price and volume information for various markets (e.g., stock symbols), and can further include fee indications, such as rebate give-up. For example, a feed 60 may directly reflect the order book database 56 by indicating a bid order of 5,000 shares of a stock at $10 with a rebate give-up of 10 mils. Feeds 60 can be configured to aggregate or average information concerning fee indications. For example, a feed 60 may indicate that 22,000 shares of a stock are subject to offer orders at $10 with an average rebate give-up of 7.2 mils. In such example, the rebate indication may be indicated as a lowest rebate give-up for a block of shares, a highest rebate give-up for a block of shares, or simply an indication that a rebate give-up exists for a block of shares. Feeds 60 may be provided to the network 14 (FIG. 1) and available to trading computers 16, other trading systems, as well as the general public.

The order matching engine 54 is configured to process fees/rebates for orders 40 based on fee matching information contained in the orders 40. In one example, orders 40 and responses 44 are provided with one or more additional fields that contain fee-matching indications 42. Fee-matching indications 42 can include an indication that a fee/rebate should be matched (e.g., a Boolean true/false), an indication of one or more remote trading systems to match the fee/rebate with or an indication of a best match from several trading systems, an indication of a differential below a matched fee or a differential above a matched rebate (e.g., 1 point below, 10% above, etc.), combinations of such indications, and the like. In another example, fee-matching indications 42 are provided by way of a specific type of order (e.g., a “fee match” order type) with its own set of fields and tags for further details about the match. In yet another example, fee-matching indications 42 are realized by a different specific type of order being provided for each different permitted type of fee/rebate match (e.g., a “rebate match with exchange XYZ” order type, a “beat exchange XYZ fee by 1 point” order type, etc.).

The order matching engine 54 can output fee/rebate to a billing system (not shown). Such information can include final fee/rebate amounts for executed orders. The billing system can interpret and present such fee/rebate amounts to trading entities. Fee-matching statements 46 may also be provided to the billing system, so that trading entities may readily understand the rationale behind their bills.

In FIG. 2, a trading server 50 of the local trading system 12 is depicted. Other trading systems, which do not implement the fee matching techniques discussed herein, such as the remote trading system 24 can include one or more trading servers 50 that implement the order gateway 52, order matching engine 54, order book database 56, and price feed interface 58. As such, the remote trading system 24 can output price feeds 60, which publish its order book or related information.

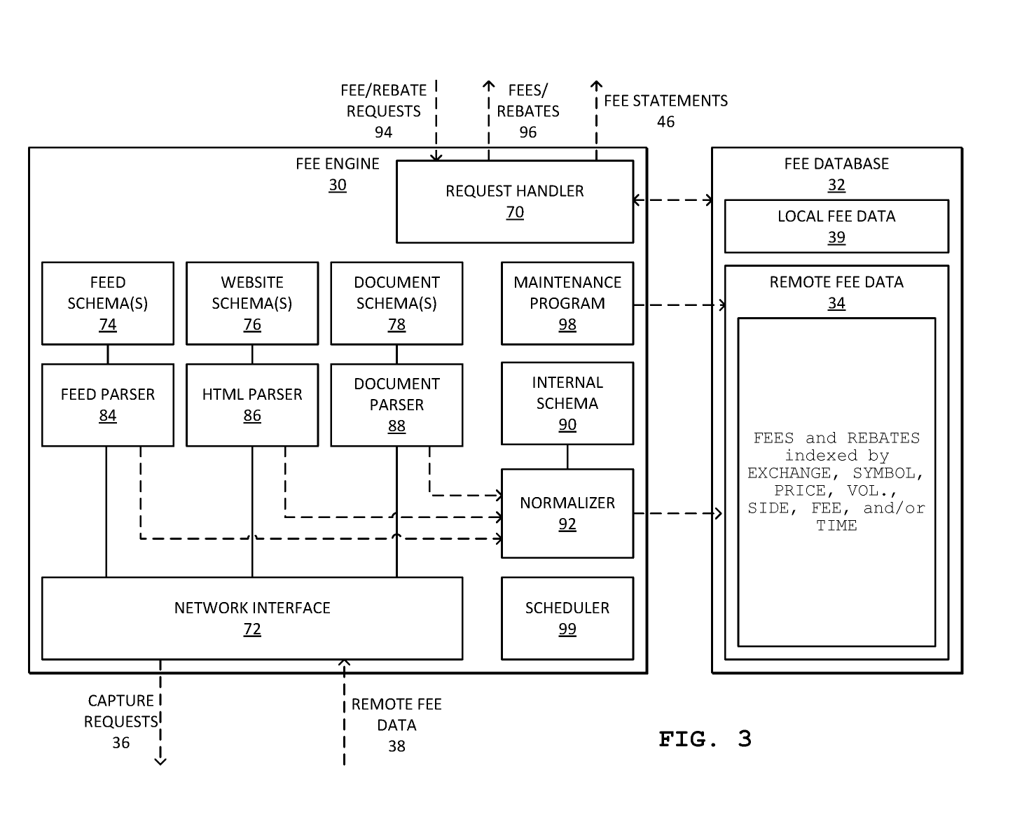

FIG. 3 shows components of the fee engine 30 according to one example.

The fee engine 30 includes a request handler 70, a network interface 72, various fee schemas 74, 76, 78, parsers 84, 86, 88 corresponding to the fee schemas, an internal schema 90, and a normalizer 92.

The network interface 72 is configured to allow the fee engine 30 to make capture requests 36 and receive fee data 38 via the network 14 (FIG. 1). The network interface 72 may include various software and/or hardware components to perform network transactions using a suitable protocol, such as HTTP or various proprietary protocols whose formats are available.

The request handler 70 interfaces with the order matching engine 54 (FIG. 2). The request handler 70 is configured to be responsive to fee/rebate requests 94 made by the order matching engine 54. Such fee/rebate requests 94 may include information about an order 40 that has been matched in a trade. For example, a fee request may indicate that a fee for the order 40 is to be matched and may further indicate a basis for the match, such as one or more of a remote exchange, a symbol, a price, a volume, and side (e.g., maker/active or taker/passive). The request handler 70 forms the request 94 into a query and queries the fee database 32 to obtain a resulting fee/rebate 96 and a corresponding fee-matching statement 46.

Fee/rebate requests 94 may take any form, with the following textual format provided as merely one illustrative example:

MATCH EXCHANGE FEE/REBATE for SYMBOL at PRICE for VOLUME traded by PASSIVE/ACTIVE at TIME

where:

MATCH is a keyword that instructs the request handler 70 to consult the remote fee data 34 to obtain a matched fee/rebate;

EXCHANGE is the name of the exchange or other trading system whose fee/rebate is to be matched, and if omitted, the request handler 70 can be configured to match the best available fee/rebate;

FEE/REBATE specifies whether a fee or rebate is to be matched;

SYMBOL is the symbol or other identifier of the financial security traded;

PRICE is the price at which the order is executed;

VOLUME is the volume traded;

PASSIVE/ACTIVE is set to the role played in the trade by the entity who owns the order; and

TIME is the time of order execution, and can be expressed as a date and time stamp.

The order matching engine 54 can construct fee requests using any of information available. The parameters FEE/REBATE and PASSIVE/ACTIVE are known to the order matching engine 54 from the structure of the trade. The remaining parameters, EXCHANGE, SYMBOL, PRICE, VOLUME, and TIME, are optional and may be provided to the order matching engine 54 with the order 40, may be determined when the order is matched, or may be controlled by settings at the order matching engine 54.

It should be noted that the above parameters are merely examples of how various exchanges may set fees/rebates. Not all parameters are required and not all parameters are expected to be available in published fee data. In one example, an exchange has one fee and perhaps one rebate, which would be represented by one or two entries of remote fee data 34. Another exchange may set fees based on volume traded, and such an exchange's fees/rebates can be represented by entries that associate fees/rebates with different levels of volume. In another example, an exchange allows trading entities to select desired fees/rebates, which are taken into account during order matching (e.g., under a price-fee-time priority matching regime). In this example, the parameters EXCHANGE, SYMBOL, PRICE, and TIME may be necessary.

The TIME parameter can be used to ensure that the most recent fee/rebate is returned for a current trade, as the remote fee data 34 may store historical fees/rebates. Further, if fee calculations are delayed, the TIME parameter can ensure that the correct historical fee/rebate available at the time of the trade is used.

The request handler 70 can be configured to manipulate the provided parameters into a query that is compatible with the fee database 32. The parameters discussed above for the example textual format may also be referenced when structuring the fee database 32. When the fee database 32 is implemented as a relational database constructed from tables, outer joins may be used for optional parameters, so that fees/rebates are returned for limit- or range-based matches, or near or subsumed matches. Operators, such as greater than or equal, less than or equal, logical not, and similar may be used in such queries when numerical parameters are used. In one example, a particular exchange may have a single fee, which is always returned regardless of any symbol, price, or other parameter provided. In another example, various exchanges may have various rebates for various levels of volume traded, and a query would return the highest rebate for the nearest cut-off volume.

When performing a match, the request handler 70 may also query the local fee data 39 and perform a comparison between the results of the queries to the local fee data 39 and the remote fee data 34, so as to return the highest rebate or lowest fee at 96. To this end, local fee data 39 and remote fee data 34 may be queried by the same query at the same time, if both the local fee data 39 and the remote fee data 34 are suitably stored in the fee database 32.

The fees/rebates returned by the request handler 70 to the order matching engine 54 may simply be a numerical value of unit fee/rebate (e.g., 35 mils). The order matching engine 54 can provide such to the billing system to calculate the actual fee/rebate to apply by, for example, multiplying the unit fee/rebate by the traded value (e.g., 35 mil fee*100 shares traded*$2.20/share trade price=$7.70 actual fee). Alternatively, the order matching engine 54 can be configured to calculate the actual fee/rebate to apply. In another alternative, the request handler 70 can be configured to calculate the actual fee/rebate to apply.

The request handler 70 may also generate fee-matching statements 46, which can include human-intelligible indications of whether and how the fee/rebate was matched. An example of a fee-matching statement is a text statement such as “Matched 35 mil fee offered by XYZ exchange.”

The fee schemas 74, 76, 78 define where and how fees are published by various remote trading systems 24 and thus how to process remote fee data 38 captured from such published fee information. Any number and type of fee schemas 74, 76, 78 can be provided. Each fee schema 74, 76, 78, as a minimum, defines the location remote fee data. Such locations may take the form of a URL or URI (e.g., http://www.example-xyz-exchange.com/fees), a network address (e.g., an IP address) and port number, or the like.

In some examples, the fee schemas 74, 76, 78 can be stored as eXtensible Markup Language (XML) files or files of another format. A fee schema 74 defines logic for parsing dynamic fee data contained in one or more feeds which may use various protocols. Examples of suitable feed protocols include tag-based ASCII protocols such as STAMP, fixed-record-length binary protocols, and other protocols such as Atom, Really Simple Syndication (RSS), and the like.

A website schema 76 defines logic for parsing fee information contained in one or more websites. The website schema 76 may take the form of XQuery and XPath expressions that identify locations in a website in which fee data is expected. A document schema 78 defines logic for parsing fee information contained in one or more documents, such as text documents, PDF documents, and the like.

The document schema 78 can, for example, specify a range of characters to capture.

The fee schemas 74, 76, 78 can be human-updatable and editable, such that the defined rules as to how the fee engine 30 is to read and process fee information can be modified based on changes at the remote trading systems 24.

The parsers 84, 86, 88 correspond to the fee schemas 74, 76, 78 and define instructions to capture and process snapshots of remote fee data 38 using the fee schemas 74, 76, 78. Any number and type of parsers 84, 86, 88 can be provided. A feed parser 84 can include a program for connecting to and digesting an Atom feed, RSS feed, or the like according to the fee schema 74. An HTML parser 86 can include a program for connecting to and digesting a website according to the website schema 76. Likewise, a document parser 88 can include a program for connecting to and digesting a document according to the document schema 78. The parsers 84, 86, 88 output captured data to the normalizer 92.

The fee schemas 74, 76, 78 and parsers 84, 86, 88 may employ regular expressions, natural-language processing, and other techniques to exclude extraneous, non-fee information from the captured fee data. Feeds are less susceptible to such extraneous information. It may be particularly desirable to use exclusionary techniques when capturing fee data from websites and other documents.

The normalizer 92 can include a program that uses the internal schema 90 to manipulate captured remote fee data 28 into a common format and store such data in the fee database 32 as remote fee data 34. The normalizer 92 can be configured to strip non-fee characters (e.g., currency symbols) or other unneeded information from data provided by the parsers 84, 86, 88. Further, the normalizer 92 can associate elements of data provided by the parsers 84, 86, 88 with fields of the fee database 32. The internal schema 90 can store such associations. Further, as remote fee data 38 from different sources may be in different units (e.g., mils, dollars, etc.), the internal schema 90 can store conversion factors that are referenced by the normalizer 92.

The normalizer 92 and internal schema 90 act to update the fee database 32. As such, the normalizer 92 may form and execute update queries on the database 32. In addition, the internal schema 90 may be an XML file or other suitable file.

The fee engine 30 can further include a maintenance program 98 that is configured to maintain the fee database 32 and, specifically, the remote fee data 34. The maintenance program 98 can drop old or expired fee data and perform other database optimizations. Fee data can be considered expired after a certain duration, such as a trading day.

The fee engine 30 further includes a scheduler 99 connected to the parsers 84, 86, 88 to provide output thereto and configured to schedule the capturing of remote fee data 38. The scheduler 99 can control the frequency, time, amount, or other parameters with which to control capture requests 36 from the parsers 84, 86, 88, and such parameters can be specified differently for the various parsers 84, 86. 88. For example, the scheduler 99 may prompt the feed parser 84 to parse the feeds specified in the fee schemas 74 frequently (e.g., every 60 seconds), and prompt the HTML parser 86 to parse the webpages specified in the website schemas less frequently (e.g., every 7 days). Such frequencies or other parameters can be stored in the fee schemas 74, 76, 78. This may allow for different locations to be parsed at different frequencies. Alternatively, the scheduler 99 can be programmed to control parsing frequencies or other parameters for the various parsers. In still another example, the functionality of the scheduler 99 is provided in each of the parsers 84, 86, 88.

The scheduler 99 can alternatively or additionally be configured to initiate the capturing of remote fee data 38 in response to the request handler 70 receiving a fee/rebate request 94. That is, the scheduler 99 is connected to the request handler 70 to receive input therefrom and respond to such input by commanding at least one of the parsers 84, 86, 88 to issue a capture request 36 for remote fee data 38.

It should be noted that the components of the fee engine 30 discussed above can be realized by software programs, hardware, firmware, or a combination of such. Furthermore, the functionalities described need not be provided to the specific components discussed, in that various components can have their functionalities combined or fragmented into smaller components.

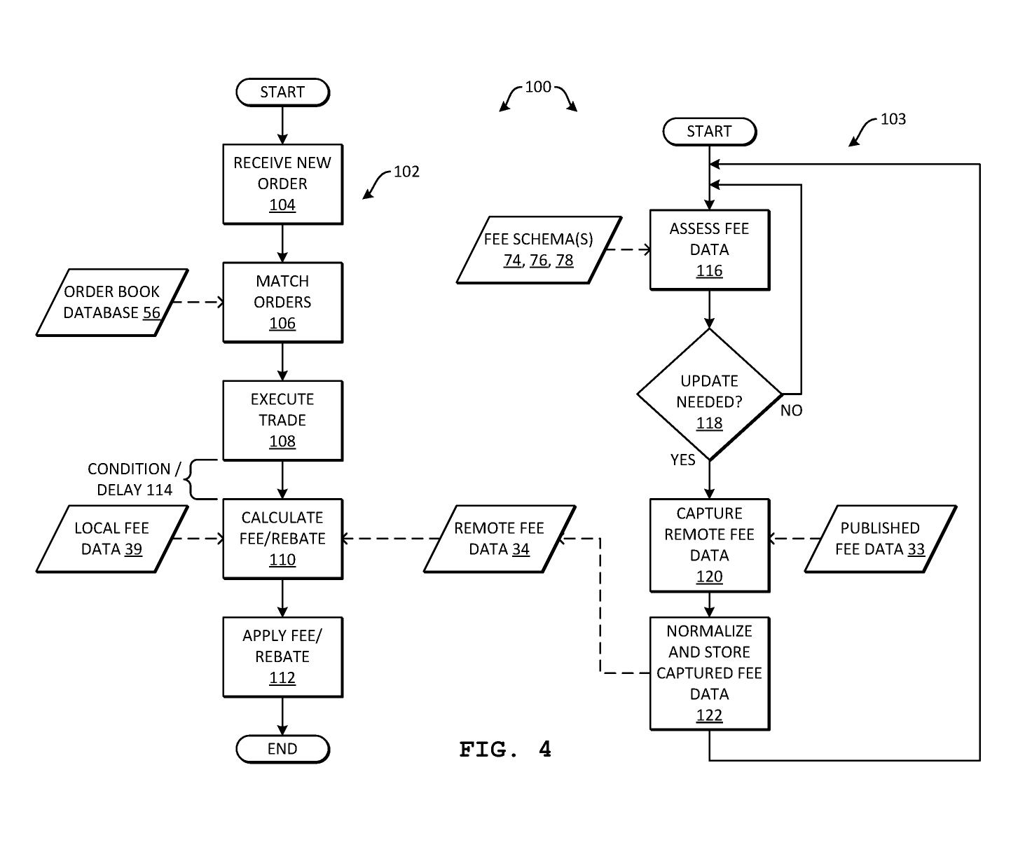

FIG. 4 illustrates a method 100 for capturing and applying fees for trades of a financial security. The method 100 can be implemented on the system described with respect to FIGS. 1-3 or on other systems. The overall method 100 includes two methods 102, 103 that can be performed independently while cooperating. The two methods include an order-execution method 102 and a fee-capturing method 103, which can be viewed as operating in parallel or asynchronously.

At step 104 of the order-execution method 102, a new order is received. Such a new order can be an active order received from a trading computer 16 (FIG. 1) or can be a passive order pulled from the order book database 56 to match a newly arriving active order. A newly arriving active order can be received by the trading server 50 (FIG. 2) at the order gateway 52.

At step 106, the order is partially or fully matched with a complementary order. The order book database 56 can supply passive orders to match received active orders. The trading server 50 and, specifically, the order matching engine 54 can perform the matching. If the order cannot be matched, it can be killed or rested in the order book database 56 and the method 102 ends.

One or more trades are then executed, at step 108, based on the matched orders. Any remaining portion of an order that is not matched can be killed or rested in the order book database 56.

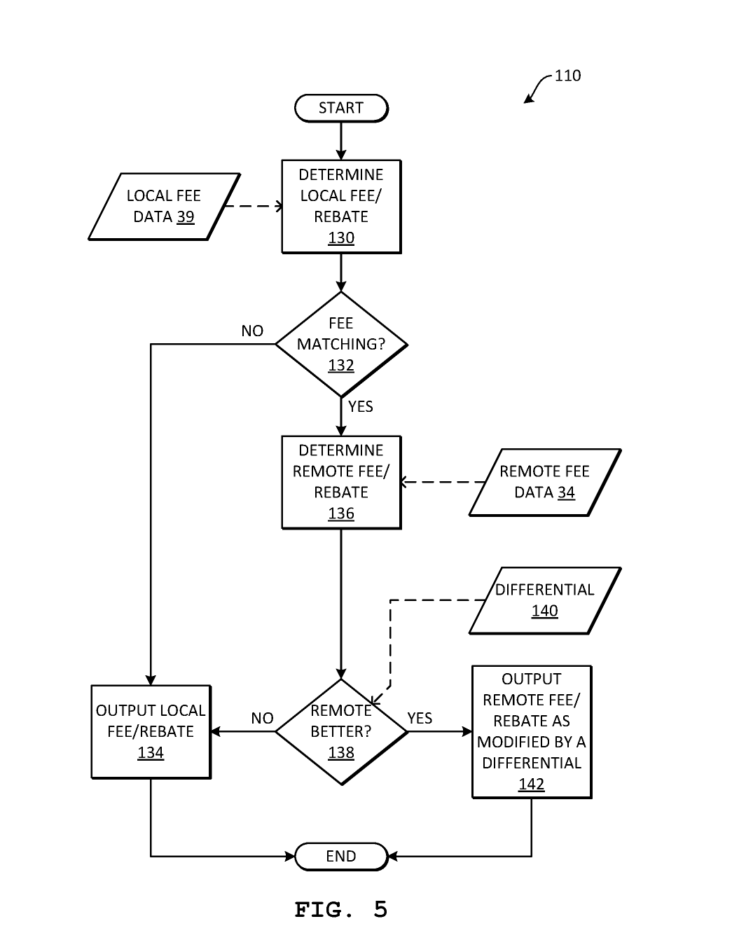

Next, the order-execution method 102 proceeds to a step of calculating fees and/or rebates, at step 110. Such calculations may reference local fee data 39 of the trading system performing the order-execution method 102. Such calculations may additionally or alternatively reference remote fee data 34 captured from, for example, published fee data 33 from one or more remote trading systems 24. Calculation of a particular fee/rebate for a particular order, at step 110, can include determining whether fee matching is to be performed and whether a local or remote fee is to be used, as will be discussed in further detail below with respect to FIG. 5.

The calculated fee/rebate is then applied to the trade at step 112. This can include notifying a billing system of the calculated fee/rebate, performing an additional calculation to convert a determined unit fee/rebate to obtain the actual fee/rebate, and other operations. Ultimately, a fee/rebate is applied to the executed order, whether originating from the local fee data 39 or the remote fee data 34.

It should be noted that the parallel nature of the methods 102, 103 permits a condition and/or delay 114 between execution of the trade at step 108 and calculating and applying the fee/rebate at steps 110, 112. A delay may merely represent the time that a processor takes to proceed from step 108 to step 110 and thus may be on the order of a fraction of a second. However, a delay may be configurable and thus selectable to be a particular duration. For instance, when a trading entity is billed at the end of a trading day or at the end of each month, the delay can be configured to an appropriate time. A condition may represent a scheduled event, such that steps 110, 112 are performed at a specific time for past trades, or another kind of condition, such as a triggering event from a billing system to determine fees/rebates.

The order-execution method 102 can be performed for each order involved in one trade. Hence, the method 102 may be performed for two orders: an active order and a passive order. Fee matching can be determined and performed independently for each such order, so that the active order is fee matched, the passive order is fee matched, both orders are fee matched, or neither order is fee matched.

The fee-capturing method 103 takes snapshots of remote fee data. The method can be performed continually and at a frequency so that such snapshots are performed at least several times per trading day or more frequently, as suitable for the nature of the dynamic or static fee data being captured.

The method 103 begins at step 116, in which an assessment of already captured remote fee data 34 is made. This is done to determine whether an update to captured remote fee data 34 is necessary, at step 118. Steps 116, 118 may be representative of a periodic update process, where the assessment is simply checking for expiry of a timer. Step 116 may alternatively or additionally include querying captured remote fee data 34, so that a determination of whether timestamps thereof are older than acceptable, at step 118. Fee data assessment at step 116 may reference fee schemas 74, 76, 78 (FIG. 3) that define how remote fee data is captured. For example, steps 116, 118 can include taking frequent and periodic snapshots (e.g., several times a minute or several times a second) of dynamic fee data from a feed defined in a schema 74. Steps 116, 118 can include less frequency snapshots for static fee data contained in webpages or other documents that is expected to be updated less frequently. Step 116 may be realized by way of the scheduler 99 of FIG. 3.

If an update is needed, step 120 captures one or more snapshots of published fee data 33 corresponding to the captured remote fee data 34 in need of update. This can be performed in accordance with the nature of the published fee data 33, which may be provided as a feed, on a website, in a document, or via another channel. One or more parsers 84, 86, 88 and corresponding schemas 74, 76, 78 may be used.

Next, at step 122, captured fee data is normalized, if required, and stored. Normalization places captured fee data into a common format, so that fee data captured from different sources can be stored together and respond to the same queries. Storing fee data can include updating a database, such as the fee database 32 (FIG. 3).

As should be apparent from the above, the order-execution method 102 and a fee-capturing method 103 are capable of being independently executed in parallel. One or both of the methods can be performed by a trading server, such as the trading server 50 of FIG. 2. The methods interact by way of remote fee data 34. Further, it should be apparent that steps 104-108 of the order-execution method 102 can be performed in response to receiving a new order, while the fee-capturing method 103 can be an ongoing, periodic process that captured remote fee data snapshots according to a schedule. Steps 110, 112 of the order-execution method 102 can be performed in line with steps 104-108 or can be performed at a later time, as billing needs require.

FIG. 5 shows an example of details of the fee/rebate calculation step 110 of the order-execution method 102.

At step 130, local fee data 39 is used to determine a local fee/rebate for the order. This is the fee or rebate that the local trading system 12 applies without fee matching.

At step 132, it is determined whether fee matching is to be performed. Such determination can include determining whether the order indicates that fee matching is to be performed, whether the trading entity behind the order normally has its fees matched, or whether one or more other conditions are met. When orders 40 are configured to provide fee-matching indications 42, step 132 can include checking for such an indication. Additionally or alternatively, fee matching may be performed globally for trades made by specific trading entities, for trades of one or more specific financial securities (e.g., stock symbols), for a specific period of time, or in other circumstances. Such global conditions can be stored in, for example, a file accessible to the fee engine 30 (FIG. 2) and can be checked as part of step 132.

If it is determined that fee matching is not to be performed, then the method proceeds to step 134 to output the local fee/rebate for use by step 112 of method 102. This may happen if the order does not specify that fee matching be performed or if global conditions for fee matching are not met.

On the other hand, if fee matching is to be performed, then remote fee data 34 is used to determine a remote fee/rebate for the order, at step 136.

Subsequently, at step 138, the better fee/rebate of the local and remote fees/rebates is determined. A differential 140 specified in the order or in a file accessible to the fee engine 30 (FIG. 2) can also be used. A differential represents an amount by which the remote fee/rebate will be beaten. When a fee is being calculated, the better fee is the lower of the local fee and remote fee less the differential. If a differential is not specified, then the better fee is the lowest of the local and remote fees. When a differential is specified, then the remote fee is reduced by the differential before being compared to the local fee, and the comparison returns the lowest value as the better fee. This allows the local trading system to beat remote trading system fees by an amount represented by the differential. For example, suppose the local trading system's fee is 35 mils and the local trading system offers to beat any remote trading system's fee by 2 mils. At step 136, the most competitive remote trading system's fee is 27 mils. Then, at step 138, 35 mils is compared to 27 mils less 2 mils, and 25 mils is selected.

Similarly, when a rebate is being calculated, the better rebate is the higher of the local rebate and remote rebate plus any differential. If a differential is not specified, then the better rebate is the highest of the local and remote rebates. When a differential is specified, then the remote rebate is increased by the differential before being compared to the local rebate, and the comparison returns the highest value as the better rebate. This allows the local trading system to beat remote trading system rebates by an amount represented by the differential.

If it is determined that the local fee/rebate is better, then the method proceeds to step 134 to output the local fee/rebate for use by step 112 of method 102. This is the same result as if fee matching were not performed.

If it is determined that the remote fee/rebate is better, then the method proceeds to step 142 to output the remote fee/rebate, as modified by any differential, for use by step 112 of method 102.

Thus, the method 110 can determine whether the local fee/rebate should be used or whether a remote fee/rebate should be used in subsequent processing. It should be noted that the method 110 acts on unit fees/rebates (e.g., mils). However, steps 130 and 136 can be configured to calculate actual fees rebates provided that the method 110 is given sufficient information about the trade.

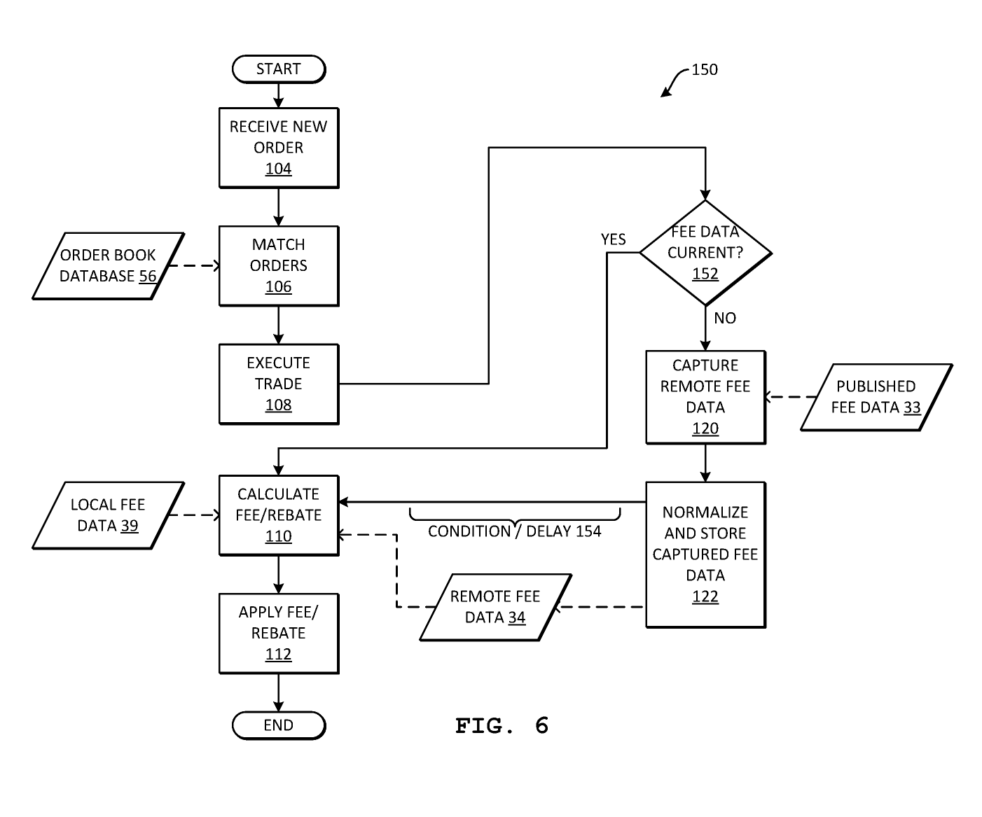

FIG. 6 illustrates a method 150 for capturing and applying fees for trades of a financial security. The method 150 can be implemented on the system described with respect to FIGS. 1-3 or on other systems. The method 150 performs order execution and remote fee capturing in series or sequentially.

The steps of the method 150 are similar to the steps of the method 100, and redundant description will be omitted for sake of clarity. The description for FIG. 4 can be referenced, with like reference numerals identifying like steps.

After receiving an order 104, matching the order 106, and executing the trade 108, the method 150 proceeds to step 152 to determine whether the relevant remote fee data is current enough to use. Step 152 can include querying the remote fee data 34 to determine a timestamp of the relevant fee/rebate and comparing the age of such timestamp to maximum age. A maximum age can be stored with each remote fee data 34 or can be stored in a file accessible to the fee engine 30 (FIG. 3). In another example, remote fee data 34 is stored with an expiry timestamp, which is queried at step 152 and compared to the current time to determine whether the relevant fee/rebate is usable. In addition, if step 152 cannot find a relevant fee/rebate in the remote fee data 34, then it is determined that the fee data is not current. In some examples, step 152 is not used and the fee data is always assumed to be not current.

If the fee data is found to be current, the method 150 proceeds to steps 110, 112 to calculate and apply the fee/rebate.

On the other hand, if the fee data is found not to be current, the method 150 proceeds to step 120 to capture published fee data 33 from one or more relevant remote trading systems 24 and normalize and store such data, at step 122. Subsequently, the method proceeds to steps 110, 112 to calculate and apply the fee/rebate.

As can be seen from the above, in the method 150, trade execution acts as a trigger to capture the relevant remote fee data for subsequent fee/rebate calculation. Hence, only remote fee/rebate data that is needed for calculation is captured.

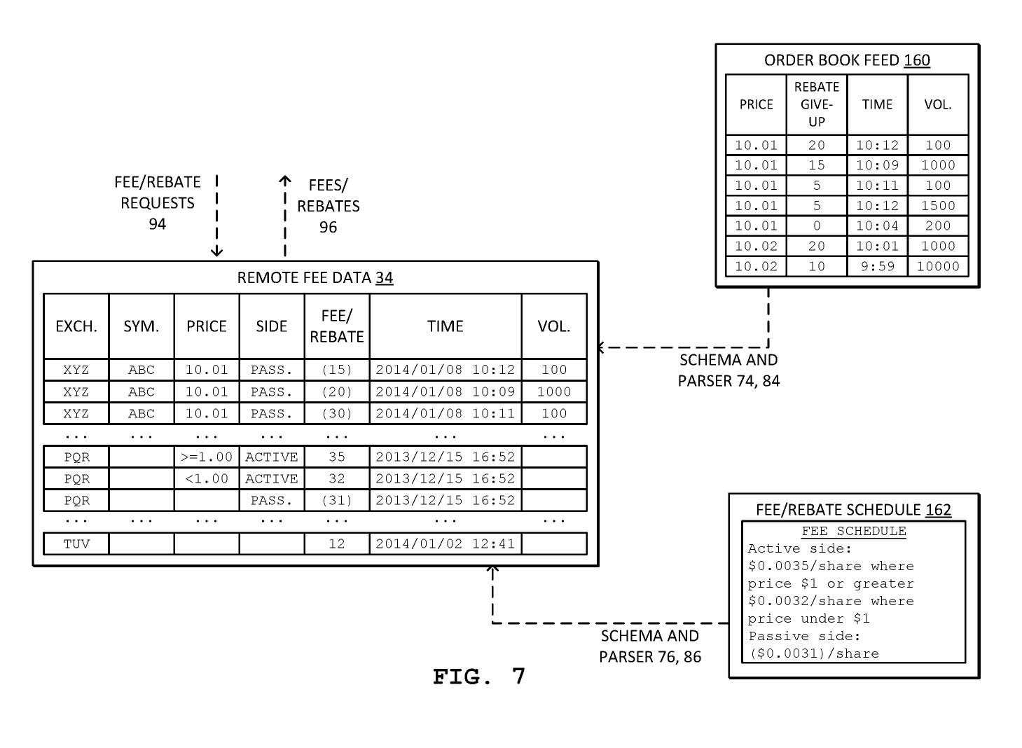

FIG. 7 shows examples data structures for the remote fee data 34, an order book feed 160, and a website fee/rebate schedule 162.

As shown, the remote fee data 34 stores fees/rebates for various exchanges, symbols, prices, sides (e.g., active/taker vs. passive/maker), timestamps, and volumes. Omitted values can me defined to match any value. Values can be stored as limits or ranges, as shown by the example prices “>=1.00” and “<1.00”. In such examples, an active order on the “POR” exchange, regardless of the symbol or volume traded, is charged a fee of 35 mils when the unit price is one dollar or more and charged a fee of 32 mils when the unit price is less than one dollar. Alternatively or in addition to storing limits/ranges, the remote fee data 34 can be queried using limit queries.

Other examples illustrate specific rebates for the passive side on exchange “XYZ” for symbol “ABC” at price “$10.01” for specific volumes. This can permit fees/rebates to be matched for very specific circumstances, such as when the “XYZ” exchange ranks its order books by price-fee-time, where fee is selectable as, for instance, a rebate give-up.

The “XYZ” exchange may operate a remote trading system 24 that publishes its price-fee-time ranked order books via one or more order books feeds 160. Such feeds 160 can be similar or identical to the feeds 60 described with respect to FIG. 2. The relevant fee schema 74 and feed parser 84 of the trading server 50 of the local trading system 12 can thus capture snapshots of the remote trading system's fees/rebates and other order information and store such as captured remote fee data 34. An order book feed 160 may be updated each time a new order is added to or removed from the underlying order book, and such updates may specify new or different trader-selected rebate give-ups. Thus, the feed parser 84 can be configured to capture the content of the order book feed 160 at a suitable frequency or as triggered by incoming fee/rebate requests 94, as discussed elsewhere herein. This allows the local trading system 12 to match dynamic and arbitrary fees/rebates being offered at a competing remote trading system.

Also shown in FIG. 7 is an example of a fee/rebate schedule published on a website 162 operated by a remote trading system 24. The trading server 50 of the local trading system 12 controls a related website schema 76 and HTML parser 86 to capture fees/rebates from such website 162. Although such websites 162 are typically relatively static with respect to feeds 160, changes can occur to fee schedules and websites 162 can be updated accordingly. So, while the website schema 76 and HTML parser 86 may not be configured to capture snapshots of the website as often as feeds 160 are captured, the website schema 76 and HTML parser 86 can be configured to capture snapshots at a frequency suitable for static fee data.

In the examples shown, the website fee data is for an exchange “POR” and provides fees for the active side based on stock price and a rebate for the passive side regardless of stock price. The timestamp represents the last time that fee data was captured from the website 162.

Also shown is a single fee of 12 mils for an exchange “TUV”, with no other conditions specified. Such an entry can be used to apply one fee to all trades.

As can be seen from the above, the techniques discussed herein allow a local trading system to match dynamic and arbitrary fees/rebates, such as those offered by a competing remote trading system. Further, the local trading system can match static fee/rebate schedules of other trading systems, such as those published on websites and in other documents. This can help promote competition between exchanges or other trading systems with regard to the fees and rebates offered to trading entities.

While the foregoing provides certain non-limiting example embodiments, it should be understood that combinations, subsets, and variations of the foregoing are contemplated. The monopoly sought is defined by the claims.

What is claimed is:

1. A method comprising:
performing order matching for at least one financial security at a local trading system, the local trading system having at least one computer connected to a computer network;
capturing remote fee data published by at least one remote trading system via the computer network, the remote fee data indicative of fees, rebates, or a combination of such applied to orders made by trading entities for execution of trades of the financial security at the remote trading system;
executing trades for the financial security at the local trading system;
the local trading system calculating fees, rebates, or combination of such for the executed trades based on the remote fee data; and
applying the calculated fees, rebates, or combination of such to the executed trades.

2. The method of claim 1, wherein capturing remote fee data comprises taking snapshots of dynamic fee data.

3. The method of claim 2, wherein the dynamic fee data includes fees selected by trading entities and published by the remote trading system for rested orders placed by the trading entities.

4. The method of claim 2, further comprising triggering the taking of a snapshot of dynamic fee data at order matching or execution.

5. The method of claim 2, wherein taking snapshots of dynamic fee data is performed at least several times per trading day.

6. The method of claim 1, wherein capturing remote fee data comprises capturing a static fee schedule published by the remote trading system.

7. The method of claim 1, further comprising storing the captured remote fee data for a selected period of time that is longer than one trading day.

8. The method of claim 7, wherein calculating fees, rebates, or combination of such for the executed trades based on the remote fee data comprises, for each executed trade, calculating a specific fee or rebate based on remote fee data that is most current with respect to a time of the executed trade.

9. The method of claim 1, further comprising receiving an order for the financial security at the local trading system, the order specifying that a fee charged by the local trading system for executing a trade based on the order is to be equal to or less than a corresponding fee offered by the remote trading system.

10. The method of claim 1, further comprising receiving an order for the financial security at the local trading system, the order specifying that a rebate given by the local trading system for executing a trade based on the order is to be equal to or greater than a corresponding rebate offered by the remote trading system.

11. A trading system comprising:
an order matching engine configured to match orders for at least one financial security, the order matching engine connected to a computer network and configured to receive orders for the financial security via the computer network;
an order book database configured to store rested orders for the financial security, the order matching engine further configured to access the order book database to match orders; and
a fee engine configured to capture remote fee data published by at least one remote trading system via the computer network, the fee engine further configured to apply fees, rebates, or a combination of such to executed orders based on the captured remote fee data.

12. The system of claim 11, wherein the fee engine is configured to take snapshots of dynamic fee data and store the dynamic fee data in memory.

13. The system of claim 12, wherein the dynamic fee data includes fees selected by trading entities and published by the remote trading system for rested orders placed by the trading entities.

14. The system of claim 12, wherein the fee engine is configured to take a snapshot of dynamic fee data at order matching or execution.

15. The system of claim 12, wherein the fee engine is configured to take snapshots of dynamic fee data at least several times per trading day.

16. The system of claim 11, wherein the fee engine is configured to capture and store a static fee schedule published by the remote trading system.

17. The system of claim 11, wherein the fee engine is configured to store the captured remote fee data for a selected period of time that is longer than one trading day.

18. The system of claim 17, wherein the fee engine is configured to use a most current set of remote fee data when applying fees, rebates, or a combination of such to executed orders.

19. The system of claim 11, wherein the order matching engine is configured to parse orders specifying that a fee charged by the trading system for executing a trade based on the order is to be equal to or less than a corresponding remote fee available from the fee engine.

20. The system of claim 11, wherein the order matching engine is configured to parse orders specifying that a rebate given by the trading system for executing a trade based on the order is to be equal to or greater than a corresponding remote rebate available from the fee engine.
